(19) United States
(12) Patent Application Publication
(10) Pub. No.: US 2012/0174090 A1
(43) Pub. Date: Jul. 5, 2012

(54) PATCH AND DOT RELEASE LICENSING

(75) Inventors: Roger Carollo, Arvada, CO (US); William Walker, Evergreen, CO (US)

(73) Assignee: AVAYA INC., Basking Ridge, NJ (US)

(21) Appl. No.: 12/983,043

(22) Filed: Dec. 31, 2010

(51) Int. Cl. G06F 9/44

(52) U.S. Cl. 717/173

(57) ABSTRACT

Methods and systems for enforcing license requirements with respect to the installation of software updates are provided. In particular, the installation of a software update requires that the system running licensed software hold a license with a validation date that is the same as or later than a publication date associated with the software update. The validation date in the license file and the publication date associated with the software update are protected against unauthorized alteration. Software updates can be installed at a date later than the validation date in the license file, so long as the validation date is not earlier than the publication date of the software update.

### FIELD

This invention relates to the licensing of software, and the enforcement of software support expiration dates.

### BACKGROUND

The release of software patches and updates, subsequent to the initial release of a software program or application, is a common occurrence. In particular, patches are released in order to address bugs or other problems after the initial release of a software product. A software update can provide new features, and can incorporate revisions comprising patches to previous software releases. In some situations, patches or dot releases are made available to software product users without a request or requirement for additional payment from those users. However, in other situations, the software provider may desire additional compensation from the product user as a condition for installing the patch or update on the user's system. Alternatively, a software provider may require that the user have in place a warranty or a service contract that entitles the software user to have access to and install the patch or update. However, one problem has been that, once an authorized user has received a patch or update, whether through additional payment or through an existing contract right, the software provider is unable to limit additional distribution of the patch or update to unauthorized users.

In order to enforce the requirement that a user provide additional payment or hold a contract right to receive and install patches or updates, software providers have implemented various controls. For example, the number of times that a patch or update can be downloaded using a particular license can be limited. However, this solution does not address the problem of the distribution of patches or updates that have been validly downloaded and then subsequently provided to unlawful/unauthorized users. Another solution is to limit the installation of patches or updates with respect to installed software and/or an associated software license having an authorized serial number. However, such an approach presents business logistics issues which are extremely difficult to manage, because doing so requires that the software provider know the serial numbers of all authorized client machines or installed software programs. In addition, such arrangements require that the software user download a separate copy of the patch or update for each instance of software operated by the user.

Another problem with controlling patches via control of the patch download is that customers often need to apply a patch published during the time they had active support/warranty, after their support/warranty expires. For example, this might be needed because the customer has to rebuild a system after a hardware failure. Given that the patch was made available when the warranty/support was active, the customer should be allowed to access this patch after the warranty/support expiration. With current art, when the support/warranty expires, all downloads are disabled to prevent access to new software updates and the customer cannot re-access the previously published patch.

Because of the difficulty and inconvenience of implementing licensing systems that prevent the creation and installation of unlimited numbers of unauthorized copies of software, software patches and updates are often made available by software providers without incorporating such controls. As a result, software providers forgo significant amounts of revenue, and are unable to enforce contractual limitations on the use of software.

### SUMMARY

Embodiments of the present disclosure are directed to solving these and other problems and disadvantages of the prior art. According to embodiments of the present disclosure, a software application or program, also referred to herein as a software product, is associated with a license file. The license file includes a validation date. A software patch or update, hereinafter referred to as a software update, is associated with a publication date. In response to an attempt to install a software update in connection with a licensed system, a comparison is made between the validation date contained in the license file and the publication date associated with the update. In accordance with embodiments of the present disclosure, this comparison is made by a license application running on the licensed system, or on a license server or other interconnected system or authority. If the validation date contained in the license file is the same as or later than the publication date associated with the software update, the installation of the software update is allowed to proceed. Conversely, if the validation date is prior to the publication date, the application of the software update is not allowed to proceed.

In accordance with embodiments of the present disclosure, the license file maintained by or in association with a licensed system generally includes a publication identifier and a validation date. As used herein, a validation date can include a service end date (SED) or a warranty end date. The publication identifier can be used to properly associate the file with licensed software and software updates. The service end date is used in connection with the verification of entitlement to software updates as described herein.

In accordance with further embodiments of the present disclosure, a software update or patch is delivered to a licensed system in a software update package comprising a patch wrapper. The patch wrapper can include a flag that indicates whether the software update is protected and therefore requires a license for installation. In addition, the patch wrapper can include a digital signature for security. The publication date of the software update being carried is also included in the patch wrapper. In accordance with further embodiments of the present disclosure, the publication date for a dot release software update is built into the software itself, and a patch wrapper is not used to deliver the dot release software update to the licensed system.

In accordance with embodiments of the present disclosure, a software application or program running on a licensed system is associated with a license file. The license file contains a validation date (most often the SED). If a software update for the licensed program is released, that update can be obtained by the licensed system from an update server. The software update can be delivered as part of a software update package that, in addition to the software update, contains a publication date associated with the software update. Upon receipt of the software update package at the licensed system, a license application can perform a comparison between the publication date associated with the software update and the validation date contained in the license file for the licensed software product. Provided the publication date is not later than the service end date, the software update can be applied to the licensed software. For dot release software updates, a license error is declared if the dot release software update's publication date is after the service end date in the license file. In accordance with further embodiments of the present disclosure, the license file maintained by or for a licensed system can be provided by a license server. Moreover, the license server can be used to administer updates or renewals of a license file. Accordingly, the validation date associated with a license file can be renewed by users or subscribers periodically.

Additional features and advantages of embodiments of the present disclosure will become more readily apparent from the following description, particularly when taken together with the accompanying drawings.

### BRIEF DESCRIPTION OF THE DRAWINGS

FIG. 1 depicts components of a licensing system in accordance with embodiments of the present disclosure;

FIG. 2 depicts an exemplary license file in accordance with embodiments of the present disclosure;

FIG. 3 depicts an exemplary software update package in accordance with embodiments of the present disclosure;

FIG. 4 is a flowchart illustrating aspects of the operation of a licensing system in accordance with embodiments of the present disclosure; and

FIG. 5 is a flowchart illustrating aspects of the operation of a licensing system in accordance with other embodiments of the present disclosure.

### DETAILED DESCRIPTION

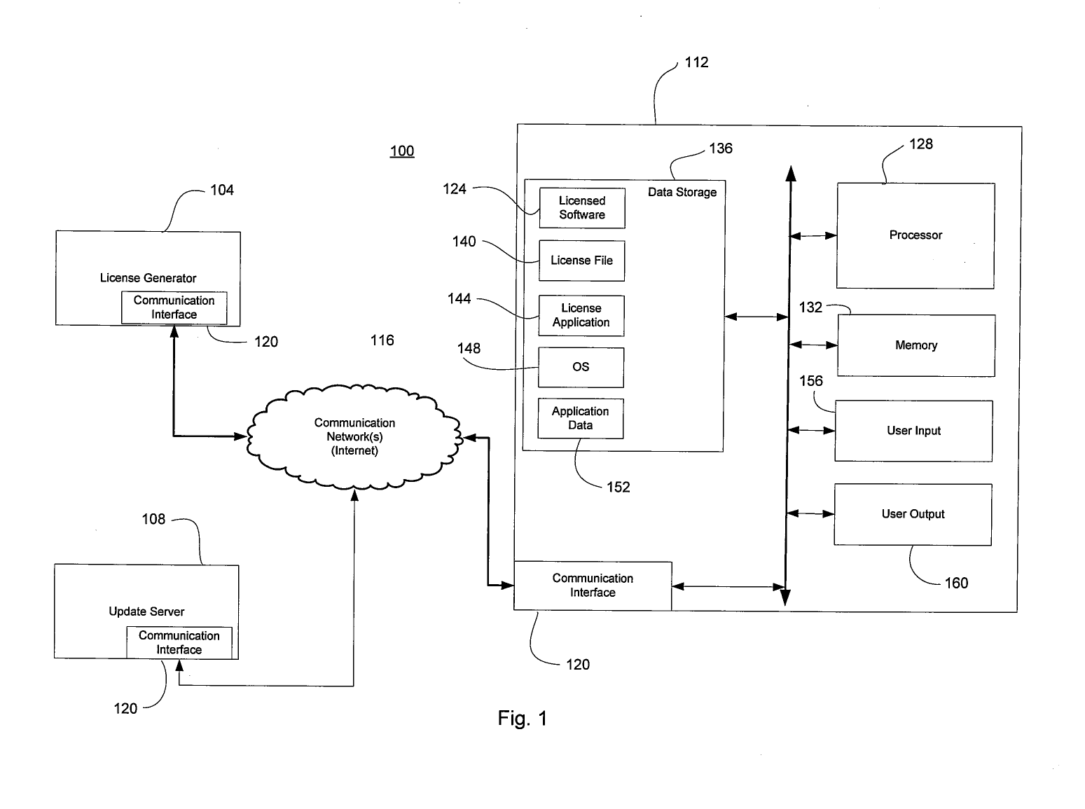

FIG. 1 illustrates an exemplary licensing system 100 in accordance with embodiments of the present disclosure. In general, the licensing system 100 includes a license server 104, an update server 108, and a licensed system 112. The various nodes 104, 108 and 112 of the licensing system 100 can be interconnected by one or more communication networks 116 that, for example but without limitation, can include the Internet.

A license generator or order-to-license system 104 can comprise a web or communications server that includes a communication interface 120 for interconnection to the communication network 116. The license generator 104 is generally operable to generate and/or update license files for association with the execution and use of licensed software. In accordance with further embodiments of the present disclosure, the license generator 104 can operate to update parameters of license files that are held by licensed users, and in particular to update associated validation dates.

The update server 108 can comprise a general purpose server device or computer. The update server 108 generally operates to distribute software updates. As used herein, a software update can, in addition to a dot release or other update, include the patch or other bug fix, or a software improvement or enhancement. The update server 108 can include a communication interface 120 to support the distribution of software updates from the update server 108 to a licensed system 112 over the communication network 116.

The licensed system 112 can comprise a general purpose computing device, such as a personal computer, work station, server, or other device that executes and/or operates in connection with licensed software 124. The licensed system 112 generally includes a processor 128 capable of executing program instructions or software, including licensed software 124. Accordingly, the processor 128 may include any general purpose programmable processor or controller for executing application programming or instructions. The processor 128 generally functions to run programming code or instructions, including licensed software 124 in connection with the performance of the functions of the licensed system 112.

A licensed system 112 may additionally include memory 132 for use in connection with the execution of software by the processor 128, and for the temporary or long term storage of program instructions and/or data. As examples, the memory 132 may comprise RAM, SDRAM, or other solid state memory. Data storage 136 can also be provided. In accordance with embodiments of the present disclosure, the data storage 136 can operate to store the licensed software 124 and other instructions or code implementing various of the applications, functions, and data stores maintained and/or executed by the licensed system 112, and data that is used and/or generated in connection with the execution of software. Like the memory 132, the data storage 136 may comprise one or more solid state memory devices. Alternatively or in addition, the data storage 136 may comprise a hard disk drive other random access memory.

In addition to the licensed software 124, other examples of software and/or data that can be stored in data storage 136 include one or more license files 140, software updates 142, license applications 144, operating system software 148, and application data 152. As described in more detail elsewhere herein, the license file 140 can include information related to the availability of software updates to the licensed system 112. A software update 142 can include instructions or code that is or that can be incorporated into licensed software 124, or that operates in cooperation with or in place of licensed software 124. The license application 144 generally functions to reference an associated license file 140 to determine whether a licensed system 112 is eligible to implement software updates in connection with licensed software 124. The operating system software 148 generally functions to provide basic functions and support for the execution of software applications for and by the licensed system 112. Application data 152 can include data that is used by licensed software 124 or other applications or programming executed by the licensed system 112, and data generated in connection with the execution of licensed software 124 or other application programming.

A licensed system 112 can also include one or more user input devices 156. For example, where the licensed system 112 comprises a server device or other computer, such as a communications server, the user input 156 can comprise a keyboard, pointing device, touch screen, and/or other devices for receiving input from an administrator. Other examples of user input devices 156 include connected thin client, personal computer, or other devices that are directly attached, or interconnected via a network, to the licensed system 112. The licensed system 112 also generally includes one or more user output devices 160. Examples of user output devices 160 include a display, an audio output device, a speaker, and indicator lamps. As with user input devices 156, user output devices 160 can be directly connected to the licensed system 112, or can provide output to a user via network connected devices. A communication interface 120 is also generally provided to support exchanges of files and/or data with other devices, such as the license generator 104 and the update server 108, via the communication network 116.

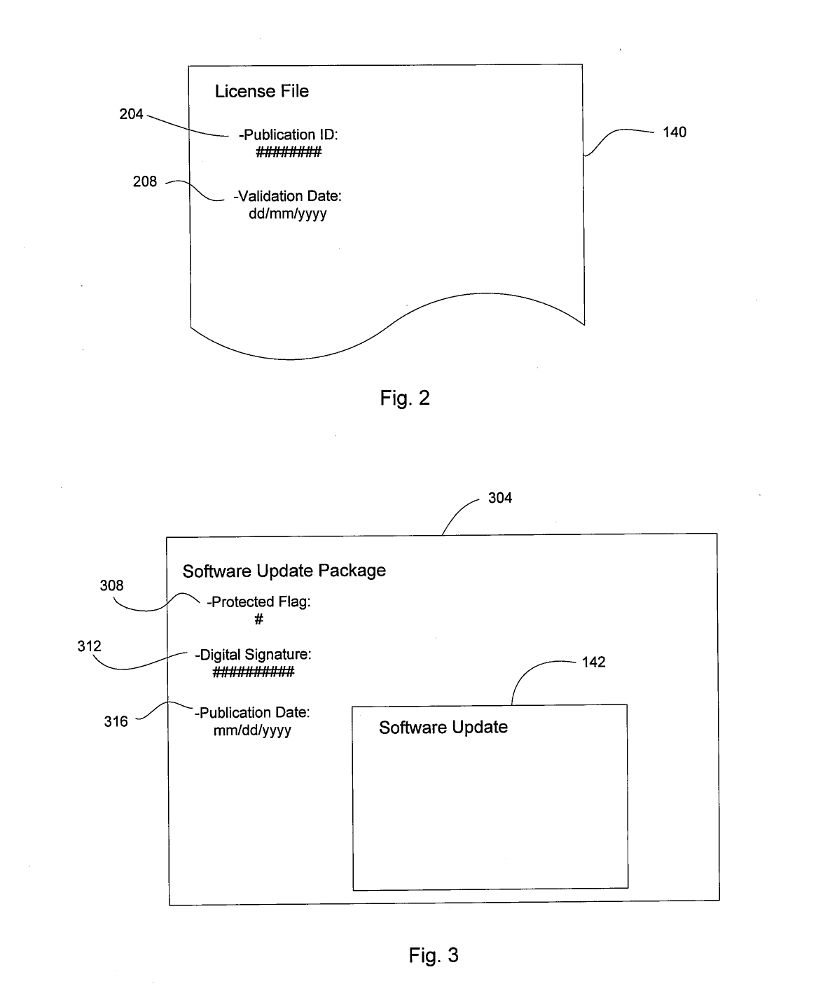

FIG. 2 illustrates an exemplary license file 140 in accordance with embodiments of the present disclosure. A license file 140 can be associated with one or more instances of licensed software 124. Moreover, a license file 140 can be associated with different licensed software 124 products. As shown, a license file 140 can include a publication identifier (ID) 204. The publication ID 204 generally provides a mechanism by which the licensed software 124 associated with the license file 140 can be identified. In addition, the license file 140 can include a validation date 208. In the example illustrated in FIG. 2, the validation date 208 is shown as a service end date (SED), and is associated with a day, month and year. Another example of a validation date 208 is a warranty end date. In general, the validation date 208 indicates the latest publication date of software updates 142 that can be validly applied to the licensed software 124 associated with the license file 140. In particular, if the publication date is the same as or earlier than the validation date 208 and is therefore valid, it is valid on any date of application, even if the calendar date of application is after the validation date. A validation date 208 that comprises a service end date generally indicates the latest publication date of updates that can be validly applied to licensed software 124 according to a service contract. A validation date 208 comprising a warranty end date indicates the latest publication date of a software update 142 that can be applied to license software 124 under a warranty. The validation date 208 can be digitally signed or otherwise protected to prevent that the date from being altered by an unauthorized user. For example, in accordance with embodiments of the present disclosure, a validation date 208 associated with a license file 140 can only validly be generated or modified by the operation of a license generator 104, for example in response to the purchase of a new or updated service agreement by a user of the licensed system 112.

FIG. 3 is an example of a software update package 304 in accordance with embodiments of the present disclosure. In general, the software update package 304 provides a wrapper for software updates 142 comprising patch software updates, and is delivered from the update server 108 to the licensed system 112 over the network 116. In addition to the patch software update 142, the software update package 304 includes a protected flag 308, which indicates whether the patch software update 142 contained therein is protected and will therefore require a valid or current license in order to apply the patch software update 142. The software update package 304 can additionally include a digital signature 312 for security purposes. A publication date 316 assigned to the software update 142 is also carried by the software update package 304. The publication date 316 is generally protected, to prevent modification by an unauthorized user. In accordance with further embodiments of the present disclosure, a software update 142 comprising a dot release software update is not delivered as part of or within a wrapper, and instead includes a publication date within the dot release software update 142 itself. As with other embodiments, the publication date can be digitally signed or otherwise protected against unauthorized modification.

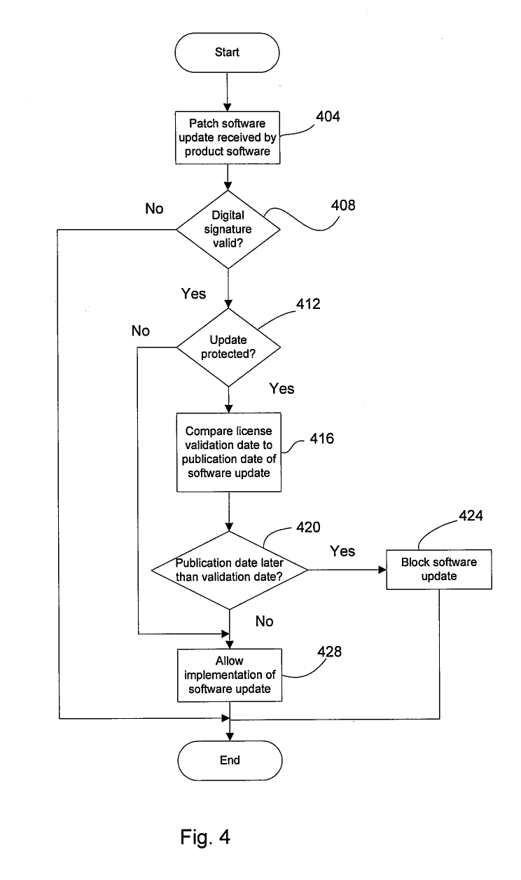

With reference now to FIG. 4, aspects of the operation of a licensing system 100 in accordance with embodiments of the present disclosure are illustrated. Initially, at step 404, a software update comprising a patch software update 142 is received by the licensed system 112. In accordance with embodiments of the present disclosure, the patch software update 142 is delivered to the licensed system 112 from an update server 108 or manually applied locally. More particularly, the patch software update 142 is delivered in a patch wrapper, that prevents unauthorized users from accessing and/or applying the patch software update 142 carried by the software update package 304.

At step 408, a determination is made as to whether the digital signature 312 included in the patch wrapper 304 is valid. If the digital signature is not valid, the process ends. If the digital signal is valid, a determination is then made as to whether the patch is protected (step 412). This determination can include determining whether a protected flag 308 is set or not. If the patch is protected, the license file 140 for the licensed software 124 that is the subject of the software update is accessed, and the validation date 208 contained in the license file 140 is compared to the publication date 316 for the patch software update 142 (step 416). In accordance with embodiments of the present disclosure, this comparison can be performed through operation of the license application 144 maintained by or on the licensed system 112. In accordance with embodiments of the present disclosure, the license application 144 may be a plug in or adjunct to another application, such as the license software 124 itself, a browser application, or other application executed by the licensed system 112.

From the comparison, a determination is made as to whether the publication date 316 associated with the patch software update 142 is later than the validation date 208 contained in the license file 140 (step 420). If the publication date 316 is later than the validation date 208, the patch software update 142 is blocked (step 424). In particular, for example through operation of the license application 144, the patch software update 142 is prevented from being installed and/or otherwise implemented. Alternatively, if the publication date 316 is not later than the validation date 208, the implementation of the software update is allowed (step 428). For example, the license application 144 can operate to extract the patch software update 142 from the patch wrapper 304, and can install the patch software update 142 such that it is executed as part of or in place of the license software 124. Implementation of the patch software update 142 is also allowed if, at step 412, it was determined that the patch software update 142 is not a protected update. After blocking (at step 424) or allowing (at step 428) the update, the process may end and/or status/error/warning messages can be displayed.

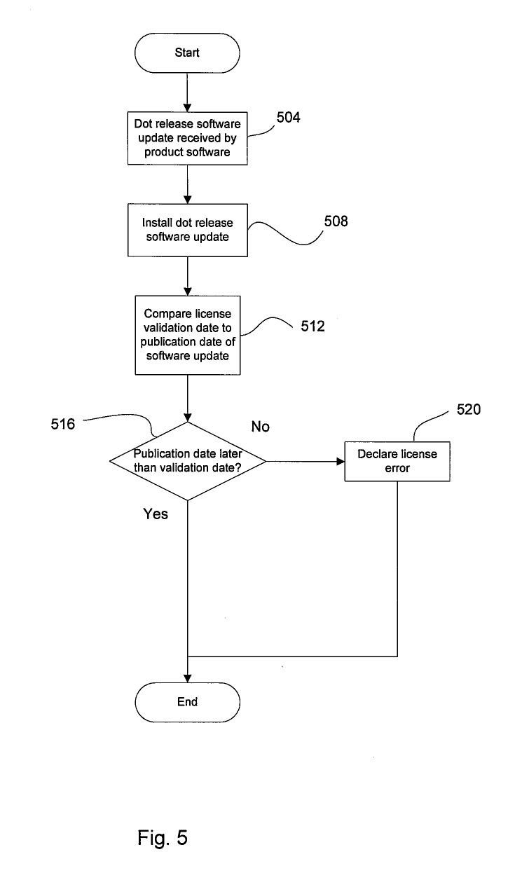

With reference now to FIG. 5, aspects of the operation of a licensing system 100 in accordance with further embodiments of the present disclosure are illustrated. Initially, at step 504, a software update comprising a dot release software update 142 is received by the licensed system 112. In accordance with embodiments of the present disclosure, the dot release software update 142 is delivered to the licensed system 112 from an update server 108 or is manually applied locally. At step 508, the dot release software update 142 is installed on the licensed system 112. At step 512, the license file 140 for the licensed software 124 is accessed, and the validation date 208 contained in the license file 140 is compared to the publication date that is built into the dot release software update 142. In particular, a determination is made as to whether the publication date of the dot release software update is later than the validation date (step 516). If the validation date 208 contained in the license file 140 is prior to the publication date included in the dot release software update 142, a license error is declared (step 520). After declaring a license error, or after determining that the publication date of the dot release software update 142 is not later than the validation date 208, the process may end and/or status/error/warning messages can be displayed.

In accordance with embodiments of the present disclosure, a software update 142 can be applied with respect to licensed software 124 associated with an appropriate license file 140 at any time, provided that the validation date 208 included in the license file 140 is the same or later than the publication date 316 of the software update 142. Accordingly, users can apply software updates 142 to licensed systems 112 during system rebuilds or other activities that may occur after the expiration of previous applicable warranty or service end dates. That is because the publication relative to the validation date has not changed. In addition, embodiments of the present disclosure allow software providers to enforce requirements that updates only be installed where the user has a suitable license, but without requiring tracking or cataloging of individual copies of licensed software 124, software updates 142 and/or licensed systems 112.

Although the description set forth herein includes examples of particular system components and features, other configurations and arrangements are possible. For example, a license generator 104 can be combined with an update server 108. In addition, delivery of license files 140 and/or software updates 142 is not required to be performed via a network 116. For example, license files 140 and software updates 142 can be delivered on storage media, such as CDs or DVDs.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present disclosure. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for updating software, comprising:
assigning a validation date to a license file associated with first software, wherein at least one of the license file and the first software is stored in first data storage;
assigning a publication date to a first software update;
accessing at a first licensed system the first software update;
in response to accessing the first software update, executing by a processor programming for comparing the validation date assigned to the license file to the publication date assigned to the first software update;
using the results of the comparison to decide whether to apply the first software update to the first software.

2. The method of claim 1, wherein a decision to apply the first software update to the first software is made in response to determining that the validation date assigned to the first license file is after the publication date assigned to the first software update.

3. The method of claim 1, wherein a decision to apply the first software update to the first software is made in response to determining that the validation date assigned to the first license file is the same as the publication date assigned to the first software update.

4. The method of claim 1, wherein a decision to deny application of the first software update to the first software is made in response to determining that the validation date assigned to the first license file is before the publication date assigned to the first software update.

5. The method of claim 1, further comprising:
receiving an authorization to update the service end date of the license file associated with the first software;
in response to receiving the authorization to update the validation date, changing the service end date assigned contained in the license file associated with the first software.

6. The method of claim 1, wherein the validation date assigned to the license file is a service end date.

7. The method of claim 1, wherein the validation date assigned to the license file is a warranty end date.

8. The method of claim 1, wherein the validation date is assigned to the license file by a license generator.

9. The method of claim 1, further comprising:
encrypting the validation date.

10. The method of claim 1, wherein the license file is associated with first and second software.

11. The method of claim 1, wherein the first software update is a patch.

12. The method of claim 1, wherein the first software update is an update.

13. The method of claim 1, wherein the first software update is accessed and applied to the first software on a date after the publication date of the first software update, and on a date after the validation date assigned to the license file.

14. A licensing system, comprising:
a first licensed system, including:
data storage, the first data storage including first software, a first licensing application, and a first license file containing a validation date;
a first processor, wherein the first processor is operable to execute the first software and the first licensing application;
a first software update, wherein a publication date is associated with the first software update;
wherein the first licensed system is operable to: receive the first software update, compare the publication date of the first software update to the validation date included in the first license file, and selectively allow or reject application of the first software update in response to the comparison of the publication date of the first software update to the validation date included in the first license file.

15. The system of claim 14, wherein at least a portion of the data storage is remote from the first processor.

16. The system of claim 15, further comprising:
a second processor, wherein the first licensed system is operable to selectively allow or reject the application of the first software update with respect to both the first and second processors.

17. The system of claim 14, further comprising:
a license generator, wherein the license generator is interconnected to a network, and wherein the license generator is operable to provide at least one of a license file and an updated validation date for the first license file to the first licenses system over a network.

18. A method for updating software, comprising:
storing a license file in data storage associated with a licensed system, wherein the license file is associated with first software and includes a first validation date;
receiving at the licensed system a first software update, wherein the first software update is associated with a publication date and the first software;
comparing by a license application running on a processor associated with the licensed system the first validation date to the publication date, wherein the first software update is applied to the first software in response to at least the publication date being prior to the validation date.

19. The method of claim 18, wherein the first software update is received as part of a software update package delivered to the licensed system over a network.

20. The method of claim 18, wherein the software update is applied after the validation date.
